(19) United States
(12) Patent Application Publication
(10) Pub. No.: US 2022/0180360 A1
(43) Pub. Date: Jun. 9, 2022

(54) METHODS AND SYSTEMS OF IMPLEMENTING A TOKEN TRANSFER FEATURE

(71) Applicant: SANDEEP AGGARWAL, Gurgaon (IN)

(72) Inventor: SANDEEP AGGARWAL, Gurgaon (IN)

(21) Appl. No.: 17/509,077

(22) Filed: Oct. 25, 2021

Related U.S. Application Data
(63) Continuation-in-part of application No. 17/065,446, filed on Oct. 7, 2020, now abandoned.
(60) Provisional application No. 62/911,379, filed on Oct. 7, 2019.
(60) Provisional application No. 62/911,377, filed on Oct. 7, 2019.

(51) Int. Cl. G06Q 20/40; G06Q 30/02

(52) U.S. Cl. CPC G06Q 20/405; G06Q 30/0222

(57) ABSTRACT

A method for implementing a token transfer feature on an online vehicle sales platform comprising the step of providing a vehicle online sales platform. The method includes implementing a conditions for applicability of a token transfer and associated calculations for a vehicle n the online vehicle sales platform. The method includes enabling that the transfer is applicable on a same category and for all sellers and while the token is transferred, creating a new list for an order. When a token amount of new listing is smaller than equal to token amount on the previous listing, then order is immediately created. When token amount of new listing is greater than the token amount of the first order, then buyer has to pay the difference through express checkout to create the second order. The method includes enabling the buyer to transfer the token amount up-to one time only. The method includes implementing a coupon transfer, wherein the coupon can only be transferred if the next online vehicle sales platform listing identifier is chosen has either same offer or any other offer.

### CLAIM OF PRIORITY

This application claim priority to and is a continuation in party of U.S. patent application Ser. No. 17/065,446, filed on Oct. 7, 2020, and titled METHODS AND SYSTEMS FOR CREDIT RISK ASSESSMENT FOR USED VEHICLE FINANCING. U.S. patent application Ser. No. 17/065,446 claims priority to U.S. Provisional Patent Application No. 62/911,379, filed on Oct. 7, 2019, and titled METHODS AND SYSTEMS OF IMPLEMENTING A TOKEN TRANSFER FEATURE. U.S. patent application Ser. No. 17/065,446 claims priority to U.S. Provisional Patent Application No. 62/911,377 , filed on Oct. 7, 2019, and titled METHODS AND SYSTEMS FOR RATING NEW VEHICLES IN AN ONLINE VEHICLE SALES PLATFORM. These applications are hereby incorporate by reference in their entirety.

### BACKGROUND

Generally, when someone wishes to purchase a used vehicle (e.g. an automobile, etc.), the user can seek the lowest price. Additionally, when selling a used vehicle, the user can seek the highest price possible. It is also a common scenario that when someone is buying a used automobile from an individual seller, the buyer can acquire the used vehicle at a much lower price than buying from an automobile dealer considering the profit margin of the dealer in the transitional transaction. Similarly, when a user is selling a used vehicle, the used vehicle can fetch a better value when the sale is made to an individual buyer than an automobile dealer as the automobile dealer would try and acquire the vehicle at a lower price and add his/her profit margin during the transitional sale. However, individual users may not have the information to maximize their quoted prices to offer their used vehicle at. Additionally, a buying non-professional user may not have sufficient information to determine a reasonable price to purchase a used vehicle.

### SUMMARY OF THE INVENTION

A method for implementing a token transfer feature on an online vehicle sales platform comprising the step of providing a vehicle online sales platform. The method includes implementing a conditions for applicability of a token transfer and associated calculations for a vehicle n the online vehicle sales platform. The method includes enabling that the transfer is applicable on a same category and for all sellers and while the token is transferred, creating a new list for an order. When a token amount of new listing is smaller than equal to token amount on the previous listing, then order is immediately created. When token amount of new listing is greater than the token amount of the first order, then buyer has to pay the difference through express checkout to create the second order. The method includes enabling the buyer to transfer the token amount up-to one time only. The method includes implementing a coupon transfer, wherein the coupon can only be transferred if the next online vehicle sales platform listing identifier is chosen has either same offer or any other offer.

### BRIEF DESCRIPTION OF THE DRAWINGS

FIG. 1 illustrates an example process for implementing a token transfer feature, according to some embodiments.

FIG. 2 illustrates an example process for provides a token transfer process flow on an online sales platform, according to some embodiments.

FIG. 3 illustrates an example process for refund process flow diagram for token transferred order, according to some embodiments.

FIG. 4 illustrates an example process for implementing refunds in an online vehicle sales platform, according to some embodiments.

FIG. 5 illustrates an example process for implementing conditions for applicability of token transfer and associated calculations, according to some embodiments.

FIG. 6 illustrates an example process for implementing an Email and SMS Communications during the Token Transfer Process, according to some embodiments.

FIG. 7 is a block diagram of a sample computing environment that can be utilized to implement various embodiments.

The Figures described above are a representative set and are not an exhaustive with respect to embodying the invention.

### DESCRIPTION

Disclosed are a system, method, and article of manufacture for a implementing a token transfer feature. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment, according to some embodiments. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### DEFINITIONS

Example definitions for some embodiments are now provided.

Token amount can be a booking amount and/or commitment amount paid by a buyer on online vehicle sales platform to make commitment for a listing.

### EXAMPLE METHODS AND SYSTEMS

In some embodiments, a token amount can be a booking amount and/or commitment amount paid by a buyer on online vehicle sales platform to make commitment for a listing. The token amount can be a fractional part of the selling price and the remaining payment is paid directly to the seller. The token amount can vary depending upon the type of category of the listing.

For Example, a vehicle can have a selling price of [symbol] 3,00,000, the buyer can be required to pay [symbol] 7,500 (2.5% of the selling price) as the token amount online on the online vehicle sales platform. The remaining final payment value of [symbol] 2,92,500 can be paid directly to the seller at the time of transaction closure.

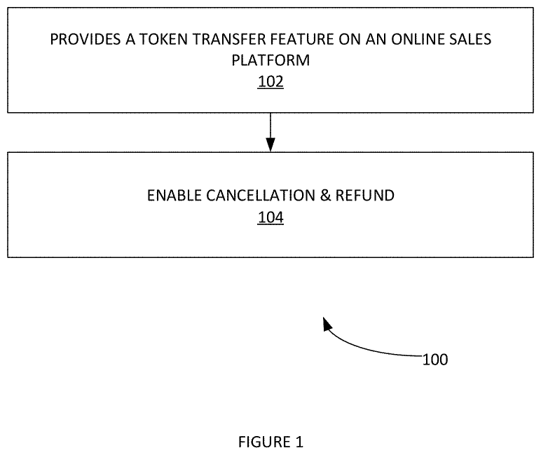

FIG. 1 illustrates an example process 100 for implementing a token transfer feature, according to some embodiments. In step 102, process 100 can provides a token transfer feature on an online sales platform. The online vehicle sales platform can provide the token transfer feature. In this way, the buyer can switch (e.g. no questions asked) a token amount from one product to another at any point of time until transaction of a first product is completed.

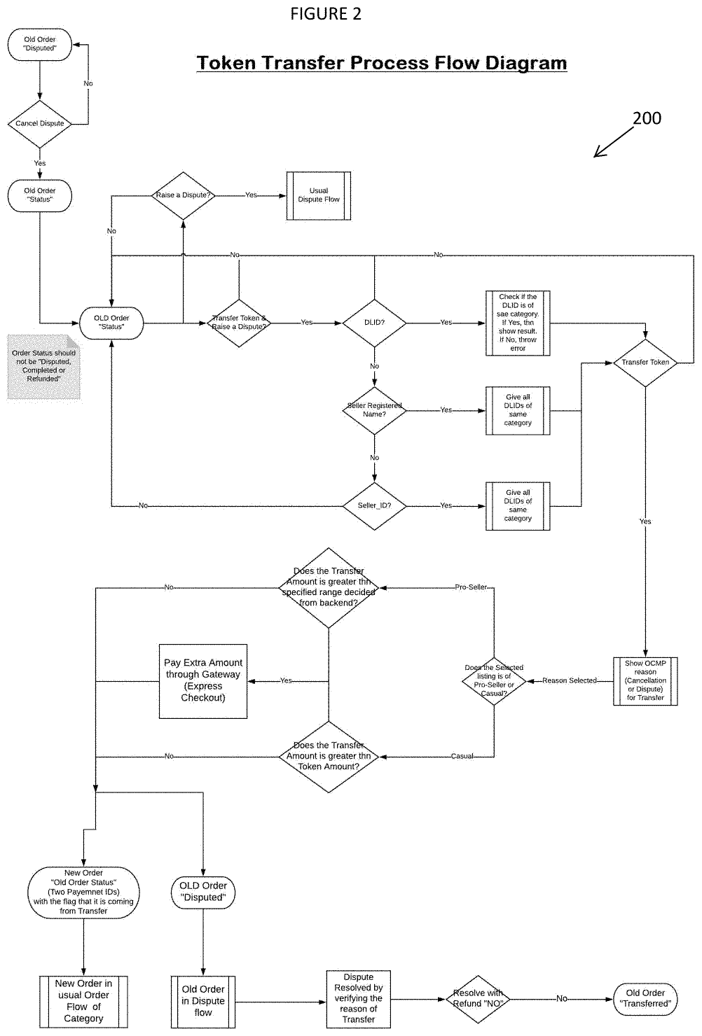

FIG. 2 illustrates an example process 200 for provides a token transfer process flow on an online sales platform, according to some embodiments. Process 200 can be used to implement step 102.

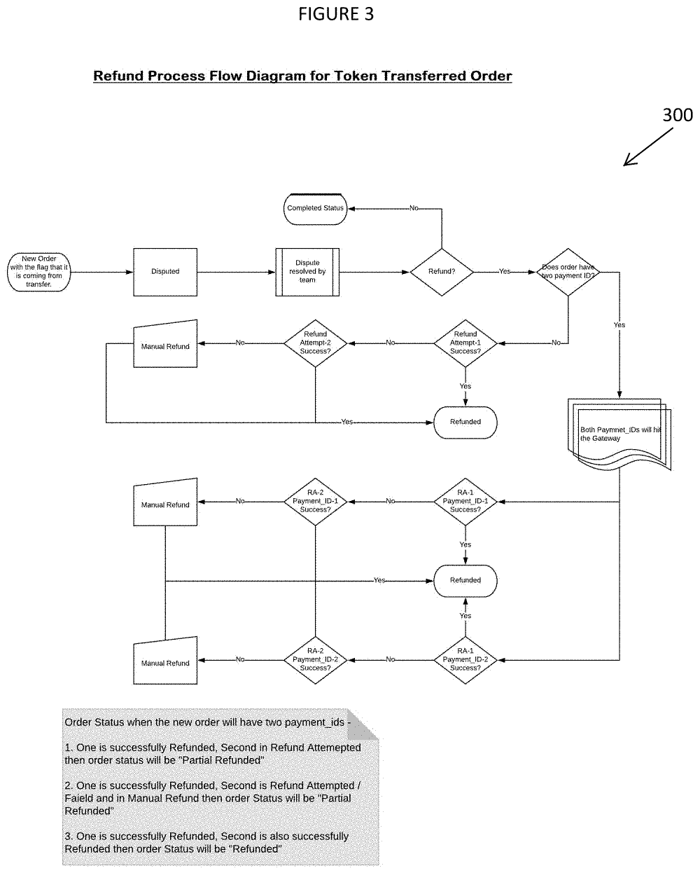

Returning to process 100, in step 104, process 100 can enable cancellations and refunds. FIG. 3 illustrates an example process 300 for refund process flow diagram for token transferred order, according to some embodiments. Process 300 can be implemented when a buyer cancels an order which the buyer created using the token transferred feature of step 102. The online vehicle sales platform then processes two refunds at the back end with the payment gateway. Step 104 and/or process 300 can be implemented using process 400.

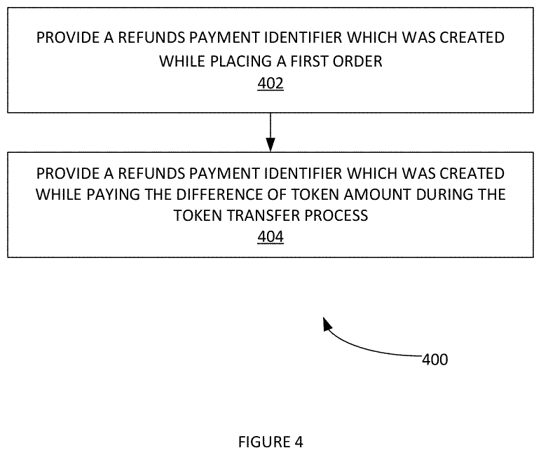

FIG. 4 illustrates an example process 400 for implementing refunds in an online vehicle sales platform, according to some embodiments. In step 402, process 400 can provide a refunds payment identifier which was created while placing a first order. In step 404, process 400 can provide a refunds payment identifier which was created while paying the difference of token amount during the token transfer process.

### EXAMPLE USE CASE

An example use case is now provided. Processes 100-400 can be utilized. Initially, the Token Transfer Process Flow can be implemented. For example, on a first day, a buyer can select a BMW M2 and pay a token amount of [symbol] 50,000 to book the vehicle. On a second day, the buyer can change his mind and decide to cancel his order. He can provide a specified reason, such as, inter alia: he did not like the chosen BMW M2 when he visited the seller; he was able to obtain a similar BMW M2 with another seller at discounted price; he decided to go with Toyota instead of BMW M2; he simply decided to not go with the booked BMW M2; etc. For seamless user experience, the online vehicle sales platform can allow the buyer (e.g. “no questions asked”) to transfer his token from BMW M2 to another chosen listing, such as a Toyota 4runner.

The buyer later logs in his account with the online vehicle sales platform. The buyer browses the catalogue of vehicles for sale and selects a new vehicle, Toyota 4runner and notes its online vehicle sales platform listing identifier. The buyer then navigates to his order history section and raises request for a token transfer relevant to the vehicle. The buyer provides noted listing identifier of the new vehicle. The buyer's order of BMW M2 is then cancelled. The buyer is routed to vehicle and checkout page to pay the difference of commitment fee for booking his new vehicle (i.e. the Toyota 4runner). The buyer pays the specified amount of funds. The new order for Toyota Fortuner is successfully placed.

### ADDITIONAL PROCESSES

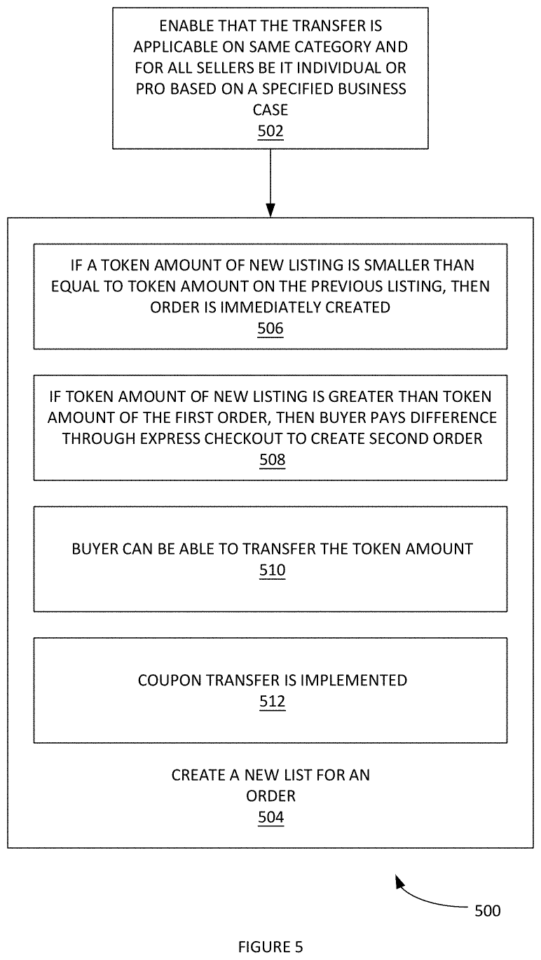

FIG. 5 illustrates an example process 500 for implementing conditions for applicability of token transfer and associated calculations, according to some embodiments. In step 502, process 500 can enable that the transfer is applicable on same category and for all sellers be it individual or pro based on a specified business case (e.g. see supra).

In step 504, while the token transferred, process 500 can create a new list for an order. Step 504 can include a set of sub-steps. In step 506, if a token amount of new listing is smaller than equal to token amount on the previous listing, then order is immediately created. For example, if buyer has first placed an order for a used BMW by paying token amount (e.g. of [symbol] 50,000). If the buyer chooses to transfer his paid token for a Toyota 4runner where the token amount is [symbol] 35,000 then the order on Toyota Fortuner is immediately created. A difference of token amounts [symbol] 15,000) is passed on to the second seller.

In step 508, if token amount of new listing is greater than the token amount of the first order, then buyer has to pay the difference through express checkout to create the second order. For example, if buyer has first placed an order for a used BMW by paying token amount of [symbol] 50,000. If now buyer chooses to transfer his paid token for a Mercedes Benz where token amount is [symbol] 75,000/—then buyer is first asked to make a payment of difference of token amount [symbol] 75,000− [symbol] 50,000= [symbol] 25,000) through an express checkout and then second order on Mercedes Benz is created.

In step 510, the buyer can be able to transfer the token amount up-to one time only. In step 512, a coupon transfer can be implemented. The coupon can only be transferred if the next online vehicle sales platform listing identifier is chosen has either same offer or any other offer. If the next online vehicle sales platform listing identifier has no offer, then the coupon may not be transferred and proper message can be displayed.

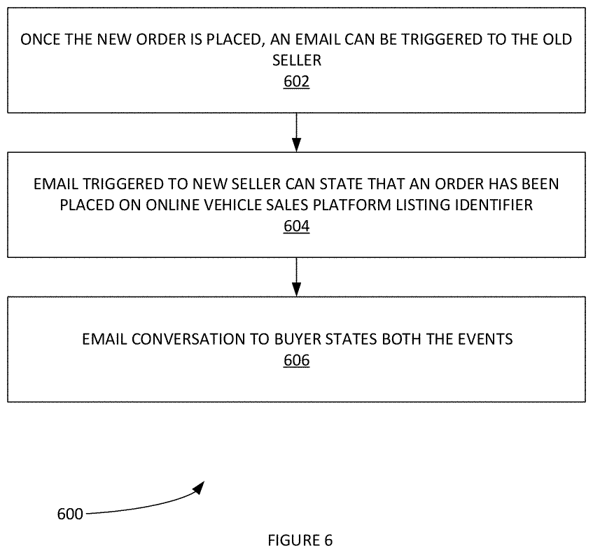

FIG. 6 illustrates an example process 600 for implementing an Email and SMS Communications during the Token Transfer Process, according to some embodiments. Process 600 can be implemented after and/or as a part of process 500. In step 602, once the new order is placed, an email can be triggered to the old seller, stating that order against the online vehicle sales platform listing identifier “Dlid1” has been cancelled as buyer has found a different listing on online vehicle sales platform. The online vehicle sales platform listing identifier “Dlid1” is active and visible to other buyers.

In step 604, the email triggered to the new seller can state that an order has been placed on the online vehicle sales platform listing identifier “Dlid2”, the buyer has chosen to use his already paid token amount to purchase your listing. The difference in amount (if any) and be adjusted in the payout.

In step 606, the email conversation to buyer can state both the events. Process 600 can have transferred the Order_ID “Order1” (Old Order) to a New Order_ID “Order2”. In this email, the details of coupon can also be shared with reason. If old coupon was removed and/or new coupon is applied and/or no coupon is used. The email can also state the reaming number of days and/or new seller details

### ADDITIONAL EXAMPLE COMPUTER ARCHITECTURE AND SYSTEMS

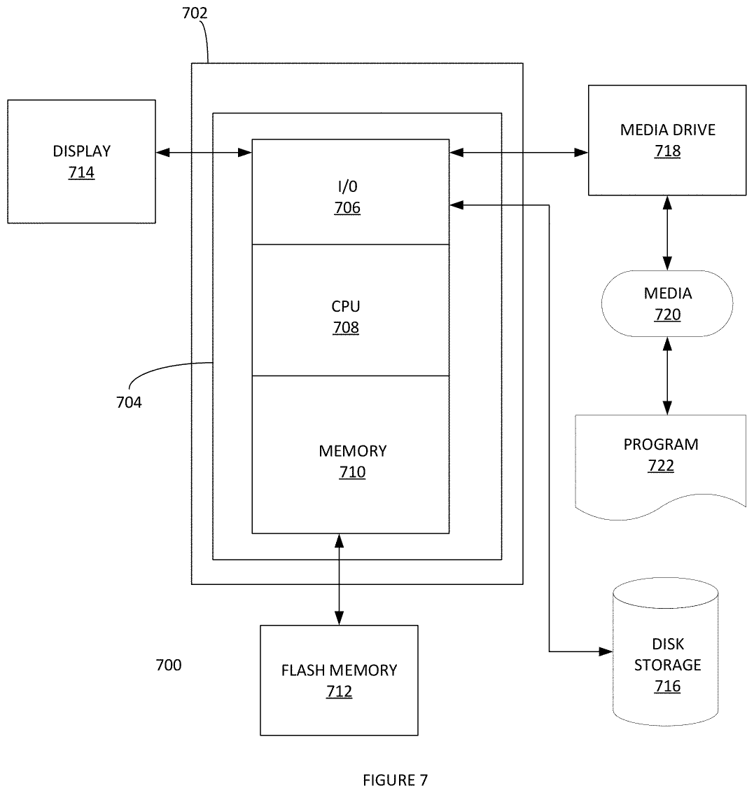

FIG. 7 depicts an exemplary computing system 700 that can be configured to perform any one of the processes provided herein. In this context, computing system 700 may include, for example, a processor, memory, storage, and I/O devices (e.g., monitor, keyboard, disk drive, Internet connection, etc.). However, computing system 700 may include circuitry or other specialized hardware for carrying out some or all aspects of the processes. In some operational settings, computing system 700 may be configured as a system that includes one or more units, each of which is configured to carry out some aspects of the processes either in software, hardware, or some combination thereof.

FIG. 7 depicts computing system 700 with a number of components that may be used to perform any of the processes described herein. The main system 702 includes a motherboard 704 having an I/O section 706, one or more central processing units (CPU) 708, and a memory section 710, which may have a flash memory card 712 related to it. The I/O section 706 can be connected to a display 714, a keyboard and/or other user input (not shown), a disk storage unit 716, and a media drive unit 718. The media drive unit 718 can read/write a computer-readable medium 720, which can contain programs 722 and/or data. Computing system 700 can include a web browser. Moreover, it is noted that computing system 700 can be configured to include additional systems in order to fulfill various functionalities. Computing system 700 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed:

1. A method for implementing a token transfer feature on an online vehicle sales platform comprising:
providing a vehicle online sales platform;
implementing a conditions for applicability of a token transfer and associated calculations for a vehicle n the online vehicle sales platform;
enabling that the transfer is applicable on a same category and for all sellers while the token is transferred, creating a new list for an order;
wherein when a token amount of new listing is smaller than equal to token amount on the previous listing, then order is immediately created,
wherein when token amount of new listing is greater than the token amount of the first order, then buyer has to pay the difference through express checkout to create the second order,
enabling the buyer to transfer the token amount up-to one time only, and
implementing a coupon transfer, wherein the coupon can only be transferred if the next online vehicle sales platform listing identifier is chosen has either same offer or any other offer.

2. The method of claim 1, wherein the token amount comprises a booking amount paid by a buyer on online vehicle sales platform to make commitment for a listing.

3. The method of claim 1, wherein the token amount comprises a commitment amount paid by a buyer on online vehicle sales platform to make commitment for a listing.

4. The method of claim 1, wherein the token amount comprises a fractional part of the selling price and the remaining payment is paid directly to the seller.

5. The method of claim 1, wherein the token amount varies depending upon the type of category of the listing of the vehicle.

6. The method of claim 1, wherein the sell comprises an individual user.

7. The method of claim 1, wherein the seller comprises a vehicle dealership. or pro based on a specified business case.

8. The method of claim 1, wherein when the next online vehicle sales platform listing identifier has no offer, then the coupon may not be transferred and proper message can be displayed.

9.
